(19) United States
(12) Patent Application Publication
(10) Pub. No.: US 2008/0242126 A1
(43) Pub. Date: Oct. 2, 2008

(54) CIRCUIT BOARD ASSEMBLY

(75) Inventors: FU-YEN TSENG, Tu-Cheng (TW); CHUN-FANG CHENG, Tu-Cheng (TW); SSU-HAN HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/877,598

(22) Filed: Oct. 23, 2007

(30) Foreign Application Priority Data
Mar. 29, 2007 (CN) 200710200347.0

(51) Int. Cl. H01R 12/14

(52) U.S. Cl. 439/78

(57) ABSTRACT

A circuit board assembly includes a circuit board, at least a conductive contact and a metal shielding device. The conductive contact is extended from a lateral edge of the circuit board and is electrically connected to the circuit board. The circuit board and the conductive contact are received in the metal shielding device with the conductive contact electrically connected to the metal shielding device. The conductive contact tightly contacts with the metal shielding device by the elasticity of the conductive contact, and the circuit board assembly can remove a static using the metal shielding device and avoid the contact failure. In addition, the conductive contact can be manufactured in manufacturing of the circuit board, the man-hour and human for affixing the conduct foam is leave out and cost is decreased.

### TECHNICAL FIELD

The present invention relates generally to electromagnetic shielding technology, and more particularly, to a circuit board assembly having a electromagnetic shielding device.

### BACKGROUND

The current trend in the electronic industry is to miniaturize components and circuits and to place as many components and circuits next to each other as possible to provide quality technical performance in a small package. Any device that conveys electrical signals, such as a wire, a printed circuit board (PCB), an integrated circuit (IC) and the like radiates and is typically susceptible to electromagnetic interference (EMI) and/or radio frequency interference (RFI). EMI and RFI affect devices by corrupting or altering electrical signals conveyed by the devices. Such corruption or alteration of the electrical signals in the devices is usually not tolerable. Thus, it is critical to shield these devices from each other and other electromagnetic interference and radio frequency interferences.

Referring to FIGS. 4 and 5, a general circuit board and a shielding case of a typical circuit board assembly for providing electromagnetic shielding is shown. The circuit board includes a body 1, and a number of grounding ends 2 electrically connected to the body 1. The shielding case 3 includes a number of conductive foam portions 4. The conductive foam portions 4 are disposed in the bottom of the shielding case 3 and configured for contacting with the grounding ends 2. After the circuit board is placed into the shielding case 3, the conductive foam portions 4 are electrically connected to the grounding ends 2 for removing static produced on the body 1.

In addition, the shielding case 3 can also protect the body 1 from EMI or RFI from outside. However, the conductive foam portions 4 are mounted on the bottom of the shielding case 3 manually, thus increasing cost. Further, manual installation of the conductive foam portions 4 may lead to error, which can lead to poor or no contact between the conductive foam portions 4 and the grounding ends 2.

### SUMMARY

In accordance with an embodiment, a circuit board assembly includes a circuit board, at least an conductive contact and a metal shielding device. The circuit board includes a base having a printed circuit formed thereon and at least a grounding end electronically connected to the printed circuit. The conductive contact is extended from a lateral edge of the base and is electrically connected to the grounding end. The circuit board and the conductive contact are received in the metal shielding device with the conductive contact electrically connected to the metal shielding device.

### BRIEF DESCRIPTION OF THE DRAWINGS

The present invention is described in greater detail hereinafter, by way of example only, through description of a preferred embodiment thereof and with reference to the accompanying drawing in which:

FIG. 1 is a schematic isometric view of a bottom of a circuit board of a preferred embodiment of the present invention;

FIG. 2 is a schematic isometric view of the circuit board of FIG. 1 assembled with a metal shielding device;

FIG. 3 is a schematic cross-section view of the assembled circuit board assembly of FIG. 2 taken along line III-III;

FIG. 4 is a schematic isometric view of a general circuit board of a related circuit board assembly; and

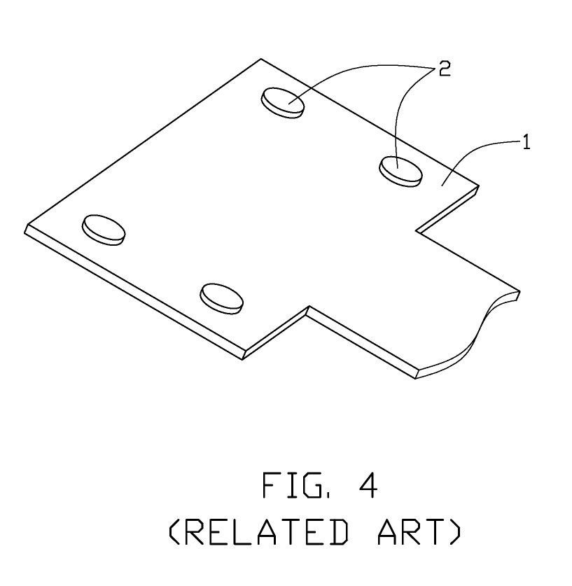

FIG. 5 is a schematic isometric view of a general shielding case for shielding the circuit board of FIG. 4.

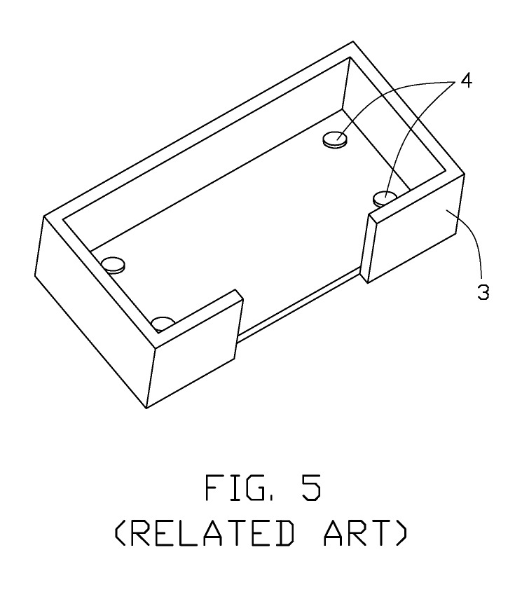

### DETAILED DESCRIPTION OF THE PREFERRED EMBODIMENTS

The detailed explanation of a circuit board assembly having a electromagnetic shielding device according to the present invention will now be made with reference to the drawing attached hereto.

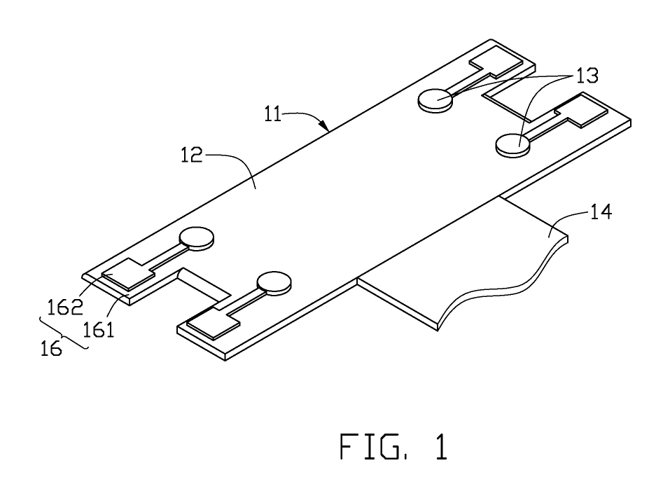

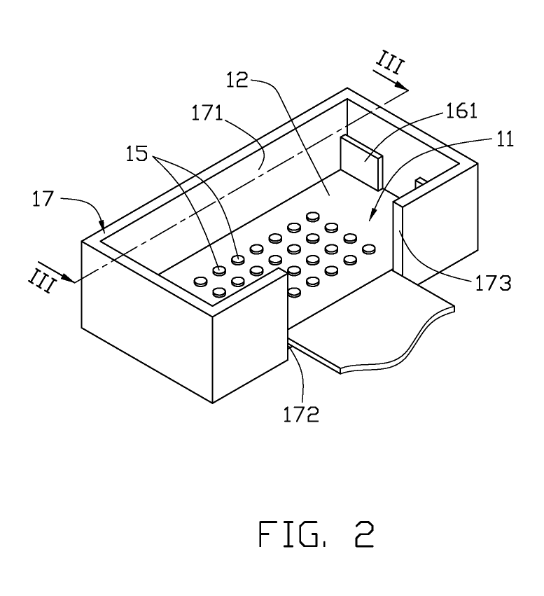

Referring to FIGS. 1 and 2, a circuit board assembly includes a circuit board 11, at least one conductive contact 16 and a metal shielding device 17. The conductive contact 16 is electrically connected to the circuit board 11. The circuit board 11 and the conductive contact 16 are received in the metal shielding device 17 with the conductive contact 16 electrically connected to the metal shielding device 17.

The circuit board 11 includes a base 12 with two opposite surfaces, at least a grounding end 13 disposed at one of the opposite surfaces, a data line 14 extending form a lateral edge connecting the two opposite surfaces and a number of pads 15 disposed at the other one of the opposite surfaces. The data line 14 is electrically connected to the pads 15 and configured for transmitting data.

The circuit board 11 can be a printed circuit board (PCB). The circuit board 11 is configured for fixing a number of electrical components (not shown) thereon. In the present embodiment, the circuit board 11 is used in a lens module of a digital camera.

The base 12 can be made from an isolative, adiabatic, flexible material. A circuit (not shown) is printed on the base 12 and is configured for conveying electrical signals between the electrical components. The at least a grounding end 13 is electrically connected to the circuit of the base 12. The grounding end 13 is configured for removing a static produced by the electric components. In this embodiment, the number of the grounding end 13 is four. The pads 15 disposed on the other one of the opposite surfaces of the base 12 are configured for welding the electrical components.

The at least one conductive contact 16 is flexibly connected with the base 12 and extended from another lateral edge of the base 12. In this embodiment, the number of the at least one conductive contact 16 is also four. The conductive contacts 16 are respectively and electrically connected with the corresponding grounding ends 13. Each of the conductive contacts 16 includes a contact base 161 and a metal portion 162 mounted on the contact base 161. The contact base 161 can be integrally formed with the base 12 and then perpendicularly bent from the lateral edge of the base 12. The contact base 161 and the base 12 can be made from same isolative, adiabatic, flexible material. The metal portion 162 can be integrally formed with the corresponding grounding ends 13 or be welded with the grounding ends 13. The metal portion 162 can be made from copper or gold. In present embodiment, the metal portion 162 is integrally formed with the corresponding grounding end 13 and is made from copper.

Referring to FIG. 2, the metal shielding device 17 can be made from a metal sheet and is punched and bent to form a rectangular container. The metal shielding device 17 includes four sidewalls 171 and a bottom wall 172 integrally formed with the sidewalls 171. The area of the bottom wall 172 is essentially equal to that of the base 12. An opening 173 is defined in one of the sidewalls 171 of the metal shielding device 17 and is configured for running the data line 14 therethrough. It can be appreciated that the width of the opening 173 is essentially equal to that of the data line 14.

In assembling of the circuit board 11 and the conductive contacts 16 into the metal shielding device 17, a position of the circuit board 11 in the bottom wall 172 of the metal shielding device 17 is restricted by the side wall 171. The conductive contacts 16 are bent up and tightly contacted with the corresponding sidewalls 171. Thus, the metal portions 162 are electrically connected with the metal shielding device 17.

It is to be understood, that the contact base 161 can be connected with the lateral edge of the base 12 in some other manner. For example, only the contact base 161 is made from flexible material, and an end of the contact base 161 is riveted with the base 12. The metal portion 162 can tightly contact with the sidewalls 171 of the metal shielding device 17 by virtue of the resilience of the contact base 161. In another aspect, the base 12 and the contact base 161 can be made from stiff material, and the conductive contacts 16 elastically connected with the circuit board 11 using an elastic member (not shown), such as a spring. The metal portion 162 can still tightly contact with the sidewalls 171 of the metal shielding device 17 by virtue of the resilience of the elastic member.

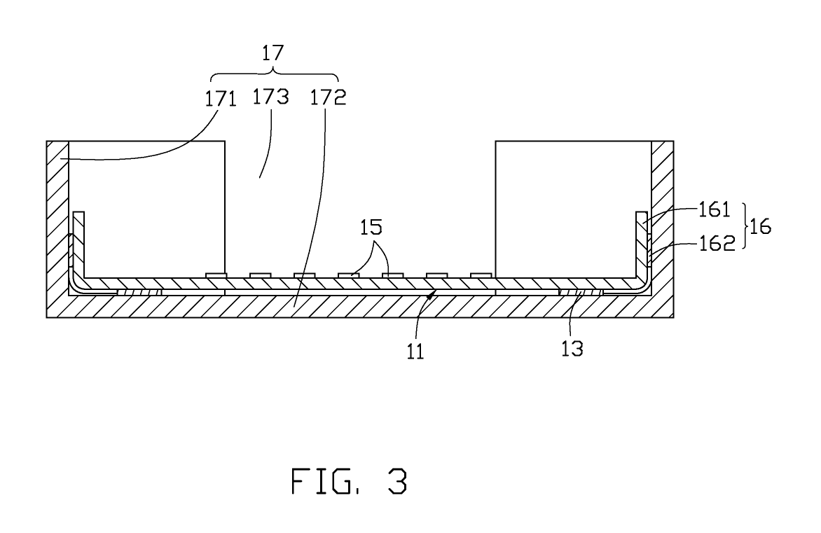

Referring to FIG. 3, due to the conductive contacts 16 being made from resilient flexible material, and the area of the bottom wall 172 of the metal shielding device 17 being essentially equal to that of the circuit board 11, the conductive contacts 16 tightly contact with the sidewalls 171 of the metal shielding device 17 after the circuit board 11 is placed into the metal shielding device 17. Thus, the metal portion 162 of each of the conductive contacts 16 is electrically connected with the metal shielding device 17. Therefore, the circuit board assembly can reliably remove static using the metal shielding device 17 and avoid the contact failure.

As described above, when finished assembling the circuit board 11, the conductive contacts 16, and the metal shielding device 17, a circuit board assembly having a function of electromagnetic shielding is achieved.

It can be understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A circuit board assembly comprising
a circuit board, the circuit board comprising a base having a printed circuit formed thereon and at least a grounding end electronically connected to the printed circuit;
at least a conductive contact extending from a lateral edge of the base, the conductive contact being flexibly connected with the base and electrically connected to the grounding end; and
a metal shielding device receiving the circuit board and the conductive contact therein, and the conductive contact being electrically connected to the metal shielding device.

2. The circuit board assembly as claimed in claim 1, wherein the conductive contact comprises a contact base flexibly connected with the base and a metal portion disposed on the contact base, the metal portion being electrically connected to the grounding end.

3. The circuit board assembly as claimed in claim 2, wherein the metal portion and the grounding end are made from same material.

4. The circuit board assembly as claimed in claim 3, wherein the metal portion is made from copper.

5. The circuit board assembly as claimed in claim 3, wherein the metal portion is made from gold.

6. The circuit board assembly as claimed in claim 2, wherein the metal portion is integrally formed with the grounding end.

7. The circuit board assembly as claimed in claim 2, wherein the contact base is integrally formed with the base and then bent from the base.

8. The circuit board assembly as claimed in claim 2, wherein the contact base and the base are all made from same material.

9. The circuit board assembly as claimed in claim 2, wherein the contact base and the base are made from flexible material.

10. The circuit board assembly as claimed in claim 1, wherein the conductive contact is made from flexible material.

11. The circuit board assembly as claimed in claim 1, wherein the number of conductive contact is same with that of the grounding end.

12. The circuit board assembly as claimed in claim 1, wherein the metal shielding device comprises a bottom wall and sidewall extending from a periphery of the bottom wall, the circuit board is supported on the bottom wall and the metal portion contacts with the sidewall.

13. The circuit board assembly as claimed in claim 13, wherein the area of bottom wall of the metal shielding device is essentially equal to that of the base.

14. A circuit board assembly comprising:
a conductive shielding device comprising a bottom wall and a sidewall extending from a periphery of the bottom wall, the bottom wall and the sidewall cooperatively forming a receiving space;
a circuit board received in the receiving space and carried by the bottom wall; and
a contact base having a conductive portion disposed thereon, the conductive portion being electrically connected to the circuit board, the contact base being connected with the circuit board in such a manner that the contact base is capable of urging the conductive portion to contact with the sidewall to thereby electrically connect the circuit board with the shielding device.

15. The circuit board assembly as claimed in claim 14, wherein the contact base and the circuit board are made from flexible material and the contact base is bent from one edge of the circuit board.

16. The circuit board assembly as claimed in claim 15, wherein at least one grounding end is disposed at one surface of the circuit board and contacts with the bottom wall of the shielding device, the conductive portion being electrically connected to the circuit board via the at least one grounding end.

17. The circuit board assembly as claimed in claim 15, wherein the area of the bottom wall of the shielding device is substantially equal to that of the circuit board.
